(19) United States
(12) Patent Application Publication
(10) Pub. No.: US 2026/0131235 A1
(43) Pub. Date: May 14, 2026

(54) Handheld Game Controller for Use with a Removal Charger

(71) Applicant: Backbone Labs, Inc., Vancouver, WA (US)

(72) Inventors: Zachary Scott, Palo Alto, CA (US); Samuel Boegli, Beaverton, OR (US)

(73) Assignee: Backbone Labs, Inc., Vancouver, WA (US)

(21) Appl. No.: 18/942,103

(22) Filed: Nov. 8, 2024

(51) Int. Cl. A63F 13/24

(52) U.S. Cl. CPC A63F 13/24

(57) ABSTRACT

In one embodiment, a game controller is provided with an opening therein for an aesthetic and/or functional purpose (e.g., to accept a removable wireless charger). In another embodiment, a game controller is provided without an opening but is capable of passing a charge and/or is capable of attaching with a removable charger. In yet another embodiment, a game controller is provided with a magnet for attaching with a mobile device and/or with a removable magnetic charger. In another embodiments, a game controller is disclosed that is sandwiched between a mobile device and a removable charger. Other embodiments are disclosed.

### BACKGROUND

A game controller can be used to provide input to a video game, for example, to control an object or character in the video game. The video game may be running on, by way of illustration, a computer, a specially-designed gaming system, a mobile device, or a server computer. Some game controllers couple with a mobile device.

### BRIEF DESCRIPTION OF THE DRAWINGS

FIG. 1 is a top view of a game controller of an embodiment.

FIG. 2 is a top view of the game controller of FIG. 1 in which a mobile device is secured between first and second handles.

FIG. 3 is a top view of a game controller of an embodiment in which the game controller has an electrical connector.

FIG. 4 is a top view of the game controller of FIG. 3 in which a mobile device is secured between first and second handles.

FIG. 5 is a top view of a game controller of an embodiment in which a mobile device is positioned on top of portions of first and second handles.

FIG. 6 is a top view of a game controller of an embodiment in which a mobile device is positioned on top of portions of first and second handles.

FIG. 7 is a side view of the game controller of FIG. 6.

FIGS. 8A and 8B are bottom views of game controllers of embodiments.

FIG. 9 is a bottom view of a game controller of an embodiment in which a magnetic charger is magnetically coupled with the game controller.

FIG. 10A is a cross-sectional view taken along line 10-10 in FIG. 9.

FIG. 10B is a cross-sectional view of a game controller of another embodiment.

FIGS. 11A-11C are illustrations of a non-magnetic removable charger of an embodiment.

FIGS. 12A-12H are illustrations of a game controller of an embodiment.

FIG. 13 is an expanded view of portion 13 in FIG. 10A.

FIG. 14 is a block diagram of a game controller charging system of an embodiment.

### DETAILED DESCRIPTION

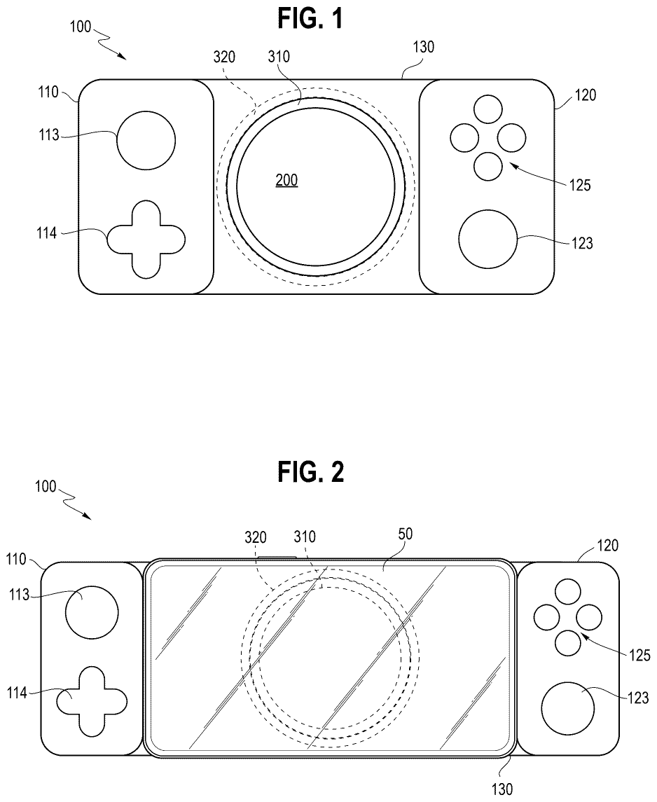

Turning now to the drawings, FIG. 1 is a top view of a handheld game controller 100 of an example embodiment. As shown in FIG. 1, the game controller 100 of this embodiment comprises a first (left) handle 110, a second (right) handle 120, and a bridge 130 coupling the first and second handles 110, 120. As will be discussed in more detail below, the first and second handles 110, 120 in this example can be in sliding engagement with the bridge 130. However, it should be understood that first and second handles of other example game controllers can move with respect to each other in any suitable way and do not necessarily need to slide along a bridge. For example, instead of moving linearly, the first and second handles can have different degrees of motion, such as when the first and second handles are foldable, flippable, or swingable. Also, first and second handles can be fixed (i.e., non-movable) with respect to each other, where the “bridge” is an integrated or separate portion of the game controller that is between regions of the game controller that can be generally designated as “handles” (e.g., because they are graspable by a user's hands), even if the “handles” do not look like individual handle components. Accordingly, the term “bridge” in the claims does not imply that the first and second handles are slidable or even movable with respect to each other, nor does the term “bridge” imply any specific configuration, unless such details are expressly recited in the claims.

The first and second handles 110, 120 of the game controller 100 in this example have a plurality of user input devices (e.g., control surfaces) that a user can manipulate to provide input to a video game (or other application) being run by, for example, a mobile device magnetically and/or physically attached to the game controller 100. In this example, the user input devices take the form of joysticks 113, 123; a directional pad (D-pad) 114; and buttons 125. The user input devices can be made of any suitable material. For example, in one embodiment, the D-pad 114 and buttons 125 can be membrane buttons, which are quieter and have a softer press compared to traditional buttons. It should be noted that the user input devices shown in FIG. 1 are merely examples, that more or fewer user input devices can be used, and that different types of user input devices can be used (such as, but not limited to, a knob, a wheel, a slider, a dial, a touch-sensitive screen/pad, a microphone for audio input (e.g., to capture a voice command or sound), a camera for video input (e.g., to capture a hand or facial gesture), etc.). Also, while FIG. 1 shows the user input devices on the top surface of the game controller 100, user input device(s) can be located on other surfaces of the game controller 100 (e.g., on the handles 110, 130 or even the bridge 130).

In this example embodiment, the first and second handles 110, 120 are slidable along the bridge 130 between a retracted position and an extended position. The first and second handles 110, 120 can be slidable, flippable, or otherwise movable in any suitable way. In one example implementation, first and second linear racks are coupled to the first and second handles 110, 120, respectively, and are in sliding engagement with the bridge 130. The first and second linear racks can be located partly in the first and second handles 110, 120, respectively, and partly in the bridge 130. A pinion can be in contact with the first and second linear racks and configured to rotate relative to the bridge 130 as the first and second linear racks are translated relative to the pinion. In this example, the handheld game controller 100 comprises a spring or other mechanism to bias the first and second handles 110, 120 toward the retracted position. However, in other implementations, the user can be required to push the first and second handles 110, 120 toward the retracted position. Also, the handheld game controller 100 can comprise a stay-open and/or stay-closed latch mechanism to temporarily lock the first and second handles 110, 120 in various position(s).

Instead of manually moving the first and second handles 110, 120, a user can interact with a physical actuator on the handheld game controller 100 (and/or a virtual actuator displayed on the mobile device 50) to cause movement of the first and second handles 110, 120.

Referring back to FIG. 1, FIG. 1 shows the game controller 100 in a default configuration in which the first and second handles 110, 120 have a relatively-short (e.g., minimum) span between them. In this position (which is sometimes referred to herein as the retracted position), the game controller 100 is in a compact configuration, in which the game controller 100 is sized for relative ease of portability (e.g., in a user's bag or pocket). A user can pull the first and second handles 110, 120 apart to an extended position to increase the span between them, such that the span is longer than the length of the mobile device. This allows the user to position the mobile device 50 between the first and second handles 110, 120.

In this embodiment, after the mobile device 50 is positioned between the first and second handles 110, 120, the user can allow or cause the first and second handles 110, 120 to move together until the inside edges of the first and second handles 110, 120 contact outer edges of the mobile device 50 to secure the mobile device 50 in place, as shown in FIG. 2. The game controller 100 is now in a game-play configuration, in which the game controller 100 is configured for use to play a video game (or interact with another application) running, for example, on the mobile device 50 positioned between the handles 110, 120. It is understood that the video game may be running on a computer, a gaming console, or a remote server(s).

As used herein, a “mobile device” generally refers to a mobile computing device, such as, but not limited to, a mobile phone or tablet, as opposed to a relatively-stationary computer or game console that is generally played at one location (e.g., home). Also, as the game controller 100 can be used to play games on the mobile device 50, the game controller 100 will sometimes be referred to herein a mobile or portable game controller, as opposed to a game controller that is used with a game console that is intended to be relatively stationary. However, the game controller of these embodiments can be used in any suitable environment, and specific configurations and uses of the game controller should not be read into the claims unless expressly recited therein. For example, in some embodiments, the game controller can be used to play a game on or otherwise interact with a mobile device when the mobile device is separate from (“stand alone”) the game controller and is not between the first and second handles. In another example, in some embodiments, the game controller can be used to play a game on a game console which is wired or wirelessly connected to the game controller. In yet another example, in some embodiments, the game controller can be used to play a game on a remote server(s), where the video game is streamed from the remote server to the game controller.

It is also understood that, in some embodiments, a mobile device may not need to be attached, or used, for such a game controller to play a video game (or interact with another application). In such instances, the game controller might be wired or wirelessly connected to, by way of illustration, a computer, a game console, a television or display device, a smart hub, a local server(s), or a remote server(s). For instance, a game controller might connect to a local device wirelessly via Bluetooth technology. In another instance, a game controller might connect to a local and/or remote device wirelessly via a data network (e.g., a wireless data network).

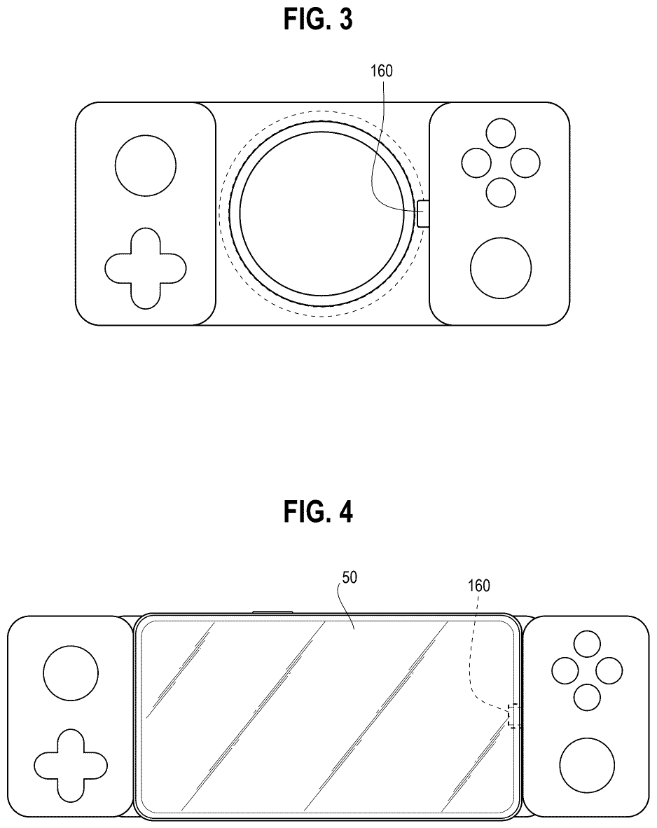

In the example embodiment of FIG. 2, the game controller 100 and mobile device 50 can communicate data for playing the video game in any suitable way. For example, data can be wirelessly communicated between the game controller 100 and the mobile device 50 via respective wireless communication devices in the game controller 100 and mobile device 50. In another embodiment (shown in FIGS. 3 and 4), the game controller can comprise an electrical connector 160 (e.g., a USB-C connector) that is configured to physically connect with a corresponding electrical connector on the mobile device 50 to provide transfer of data and/or power. In yet another embodiment, the game controller can have both an electrical connector and a wireless communication device, where game data is passed via the wired electrical connector and non-game data (e.g., set-up/identification information to pair the game controller with the mobile device) is passed wirelessly.

As noted above, in one example embodiment, the mobile device 50 is mechanically secured to the game controller 100 via physical contact with the first and second handles 110, 120. Additional elements can be provided to further secure the mobile device 50 to the game controller 100. For example, the first and second handles 110, 120 can contain overhang portions to contact portions of the top surface of the mobile device 50 to help further secure the mobile device 50 in the “Z direction” (i.e., the direction upward and perpendicular to an axis (in the “X direction”) running between the first and second handles 110, 120). Additionally, the first and second handles 110, 120 and/or bridge 130 can have fixed or removable support pads made from a compliant material that cushion and grip edges of the mobile device 50 when placed between the first and second handles 110, 120. Such pads can help further secure the mobile device 50 in the “Y direction” (i.e., the direction perpendicular to X direction and generally parallel to the first and second handles 110, 120).

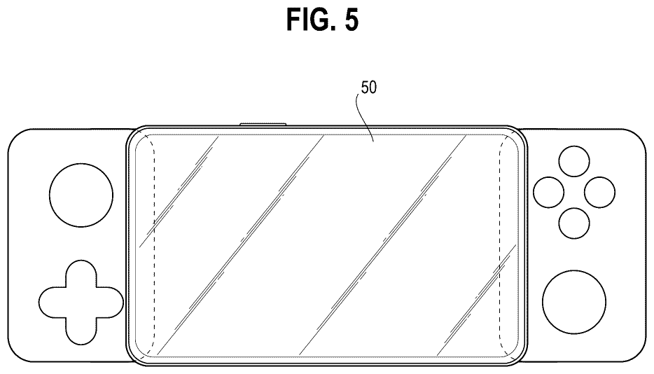

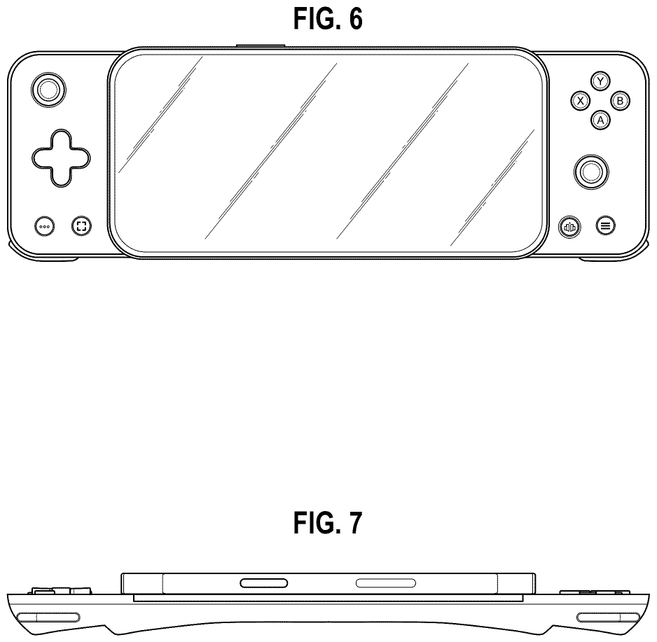

Instead of or in addition to physically securing the mobile device 50 to the game controller 100, the mobile device 50 can be directly or indirectly magnetically attached to the game controller (e.g., via a magnetic connector built into the game controller or, as will be described below, via a removable magnetic connector attached to the game controller). For example, FIG. 5 shows an alternative to the game controller 100 of FIG. 1, where the mobile device 50 sits on top of portions of the first and second handles when in an extended position rather than being pressed between the first and second handles. As such, it is only the magnetic connection—and not the mechanical coupling between the first and second handles—that secures the mobile device to the game controller (though, mechanical coupling may be used along with the magnetic connection if so designed). Other game controller configurations are possible. For example, FIGS. 6 and 7 are top and side views, respectively, of another game controller design where the mobile device 50 is positioned on top of portions of the first and second handles when the first and second handles are pulled apart to an extended position. In this design, when the first and second handles are in their default, retracted position, a user input device of at least one of the first and second handles is concealed by the mobile device, but that user input device is exposed from under the mobile device when the first and second handles are pulled apart to the extended position. Other example game controller designs are described below.

The game controller can have a built-in charger to charge a mobile device when the mobile device is near or in contact with the game controller. For example, the game controller can have a built-in magnetic connector and charger to magnetically attach a mobile device to the game controller and wirelessly charge the mobile device (from a power source and/or from the game controller's internal battery, for example) when the game controller and mobile device are magnetically connected. The magnetic connector may also provide wireless data transfer between the mobile device and the game controller. However, in this embodiment, the game controller 100 does not have a built-in charger but instead uses a removal charger, which can be magnetic or non-magnetic. There are several advantages to this design. For example, by not having a built-in charger, the game controller 100 can be relatively more light-weight and portable, as a built-in charger can add weight (and possibly bulk) to the game controller. Also, many users may already have a third-party removable charger (e.g., a MagSafe charger), so they do not need a built-in charger (nor do they need to incur the added expense of buying an extra charger). Further, this design leverages the technology of third-party chargers, avoiding the need for a manufacturer of the game controller to “reinvent the wheel” in designing its own charger. These and other advantages will be apparent to one of ordinary skill in the art upon consideration of the description and figures.

A removable charger can be accommodated by the game controller in any suitable way. For example, referring back to FIG. 1, in the game controller 100 of this embodiment, the bridge 130 has an opening 200 formed therein that is sized to accept a removable charger. The opening 200 in the game controller 100 in this embodiment provides a “pass through” for the removable charger. (In other embodiments, an opening in the game controller is not used as a “pass through” for a removable charger but is instead used for another functional purpose and/or for an aesthetic purpose.) In some embodiments, the opening 200 can be formed-fitted to the outer shape of a specific removable charger (or to a category of removable chargers). In other embodiments, the opening 200 can be sized large enough to accept a variety of sizes of removable chargers, where some types of removable chargers may form-fit into the opening 200, and smaller removable chargers may not. Magnets in smaller magnetic chargers can be used to self-locate in the opening 200 to prevent the extra radial clearance from being a problem.

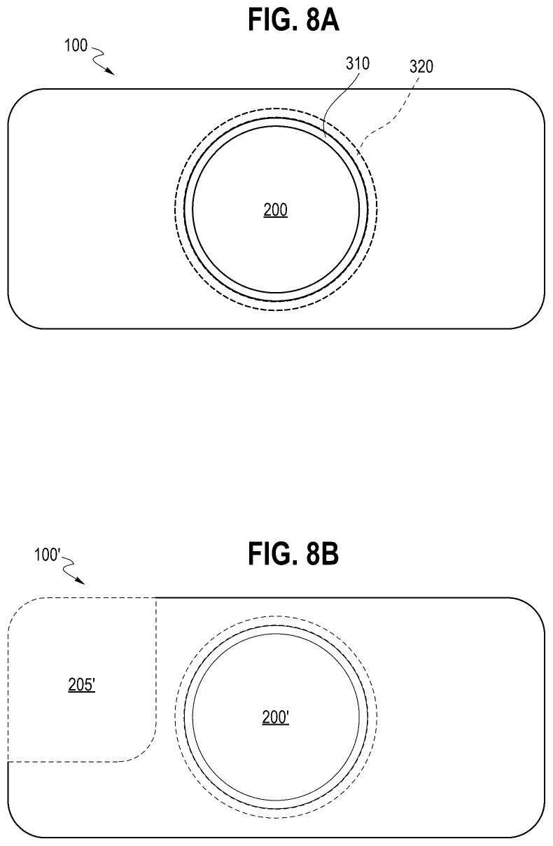

While the opening 200 in this example is circular, it should be noted that any suitable shape can be used (e.g., if the removable charger is square shaped, the shape of the opening can also be square shape or another non-circular shape). Further, while the opening 200 can be the sole opening on the bottom of the game controller 100 (see FIG. 8A), in other embodiments, additional openings are provided. For example, as shown in the alternate embodiment in FIG. 8B, in addition to the opening 200′ for the removable charger, the game controller 100′ has an opening to accommodate camera lenses of the mobile device.

As mentioned above, the removable charger can be magnetically or non-magnetically attachable to the game controller. In this example, the removable charger takes the form of a removable magnetic charger 300 that is magnetically attachable to the game controller. However, in other examples, the removable charger is non-magnetically attachable to the game controller or is both magnetically and non-magnetically attached to the game controller. Accordingly, the use of a magnetic removable charger should not be read into the claims unless expressly recited therein.

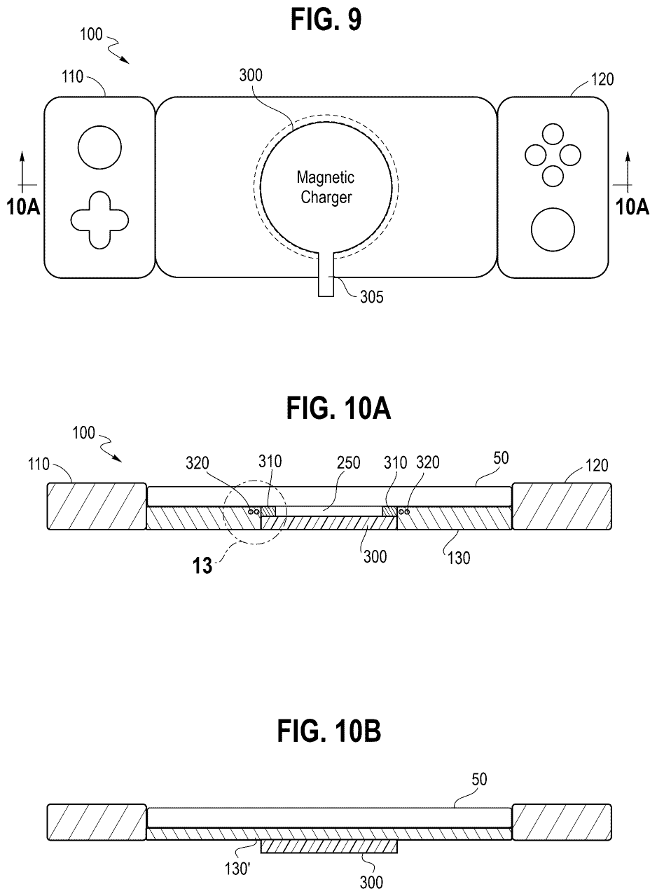

In this embodiment, a passive attachment magnet 310 is optionally concentrically located around the opening 100. The attachment magnet 310 can comprise one or more magnets. In this example, the attachment magnet 310 takes the forms of a ring magnet, which can comprise, for example, a plurality of individual magnets arranged in a ring or can comprise a single ring-shaped magnet. One side of the attachment magnet 310 is configured to magnetically attach with the mobile device 50 when placed adjacent to the opening 200 to at least partially secure the mobile device 50 with the game controller 100. The other side of the attachment magnet 310 is configured to magnetically attach with a removable magnetic charger 300 placed within the opening 200 (see FIG. 9). In this way, the mobile device 50 and the removable magnetic charger 300 are magnetically attached on opposite sides of the opening 200.

The bottom of the game controller 100 can also comprise an opening to accommodate the power cord 305 of the magnetic charger 300, if needed. The other end of the power cord 305 can be plugged into a wall outlet or into a portable battery, for example.

FIG. 10A is a cross-sectional view showing a configuration in which the magnetic charger 300 is placed within the opening 200 on the bottom of the game controller 100 and the mobile device 50 is placed on the top of the game controller 100. As shown in this cross-sectional view, the magnetic charger 300 magnetically attaches with the bottom side of the attachment magnet 310, and the mobile device 50 magnetically attaches with the top side of the attachment magnet 310. In this embodiment, the mobile device 50 is also mechanically secured to the game controller 100 by being mechanically pressed between the two handles 110, 120. (The electrical connector 160, when used, can also provide some mechanical securing (see FIGS. 3 and 4)). However, as noted above, in an alternate embodiment, the mobile device sits on top of portions of the first and second handles, in which case, the magnetic attachment is the sole securing force (or substantially the sole securing force) between the mobile device and the game controller.

In addition to being magnetically attached with the attachment magnet 310, the mobile device 50 is magnetically attached with the magnetic charger 300. Here, there is a gap 250 defined by the thickness of the attachment magnet 310, and the gap 250 is sufficiently small to allow for a sufficiently-strong magnetic connection to at least partially secure the mobile device 50 to the game controller 100. The gap 250 can be sized to accommodate a case of the mobile device 50. In other embodiments, no gap is present.

As shown in FIG. 10A, in this embodiment, the game controller 100 is at least partially “sandwiched” between the mobile device 50 and the removable magnetic charger 300 by virtue of the attachment magnet 310 being pressed between the mobile device 50 and the removable magnetic charger 300 when those components are magnetically connected. In this example, it is bridge 130 (or at least some portion thereof) that is “sandwiched” between mobile device 50 and the removable magnetic charger 300. If the magnetic connection between the mobile device 50 and the magnetic charger 300 is sufficiently strong, the attachment magnet 310 may not be needed or desired. In that situation, the attachment magnet 310 can be replaced with a non-magnetic (or less magnetic) material, so the game controller 100 would be secured to the mobile device 50 and the removable magnetic charger 300 solely by being “sandwiched” between those components. Nonetheless, use of the attachment magnet 310 may be desired to improve the user's experience by providing a fast and “snappy” interaction when the user connects the mobile device 50 and/or the removable magnetic charger 300 to the game controller 100.

In another alternative, the game controller does not have an opening for a removable magnetic charger. In this alternative (see FIG. 10B), a solid area of the game controller (here, the bridge 130′) is sufficiently thin to pass a charge and/or allow attachment when the removable magnetic charger 300 is located adjacent one side of the bridge 130′ and the mobile device 50 is located adjacent an opposite side of the bridge 130′. This alternative recognizes that the distance between the removable magnetic charger 300 and the mobile device 50 can be a constraint, as there may be a minimum required distance between the removable magnetic charger 300 and the mobile device 50 to allow for wireless charging and/or attachment. Such a constraint may be satisfied, for example, by using a thinner material for the bridge 130′ (or, for other configurations, other areas of the game controller that contacts the removable magnetic charger 300 and the mobile device 50).

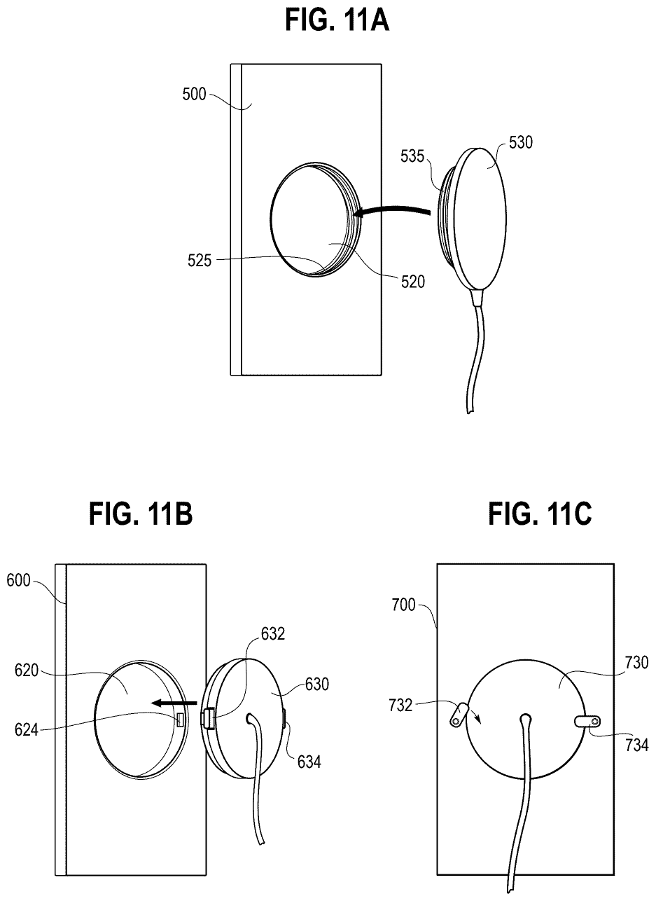

Many other attachment alternatives are possible. For example, as mentioned above, a removable charger can be used that is non-magnetically attachable to a game controller. FIGS. 11A-11C illustrate examples of this alternative. In the example shown in FIG. 11A, the opening 520 in the game controller 500 and the removable charger 530 have respective threads 525, 535 that allow the removable charger 530 to be screwed into and out of the game controller 500. In the example shown in FIG. 11B, the removable charger 630 has bendable tabs 632, 634 to press-fit the removable charger 630 into the game controller 600. The bendable tabs 632, 634 compress when the removable charger 630 is initially pushed into the opening 620 and then expand into corresponding holes 624 within the opening 620 when the removable charger 630 is fully inserted into the opening 620, which securing the removable charger 630 into the game controller 600. To remove the removable charger 630, the user would squeeze the tabs 632, 634 together and pull the removable charger 630 out of the opening 620. In the example shown in FIG. 11C, the game controller 700 has pivotable arms 732, 734 that a user can move to secure and allow removable of the removable charger 730. It should be understood that these are merely examples and that other non-magnetic securing mechanisms can be used. Also, a non-magnetic securing mechanism can be used in combination with a removable magnetic charger (e.g., to prevent accidental removable of the removable magnetic charger when the power cord of the charger is accidentally pulled).

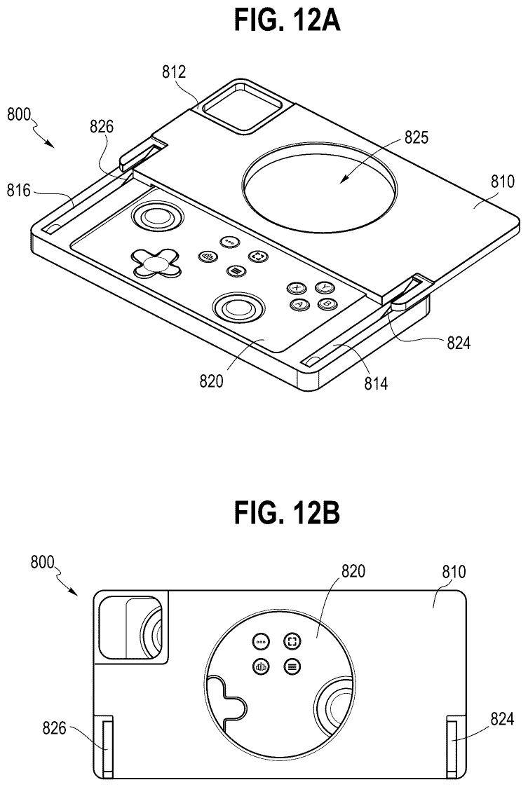

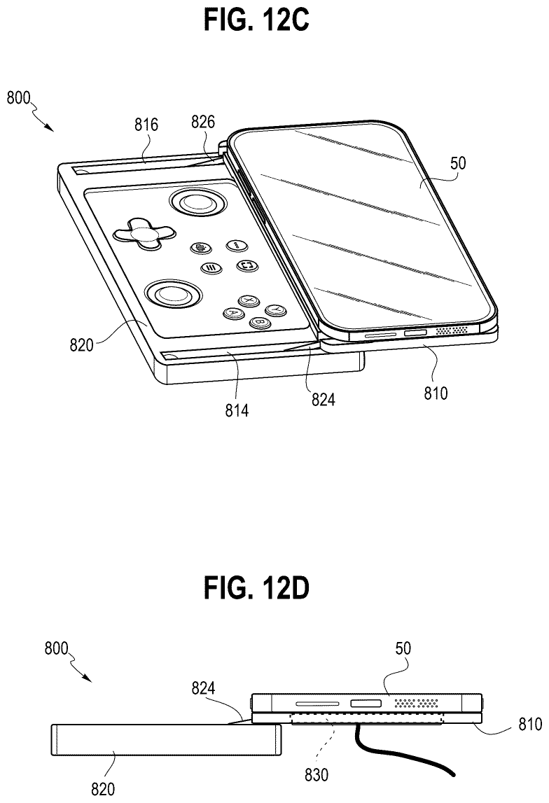

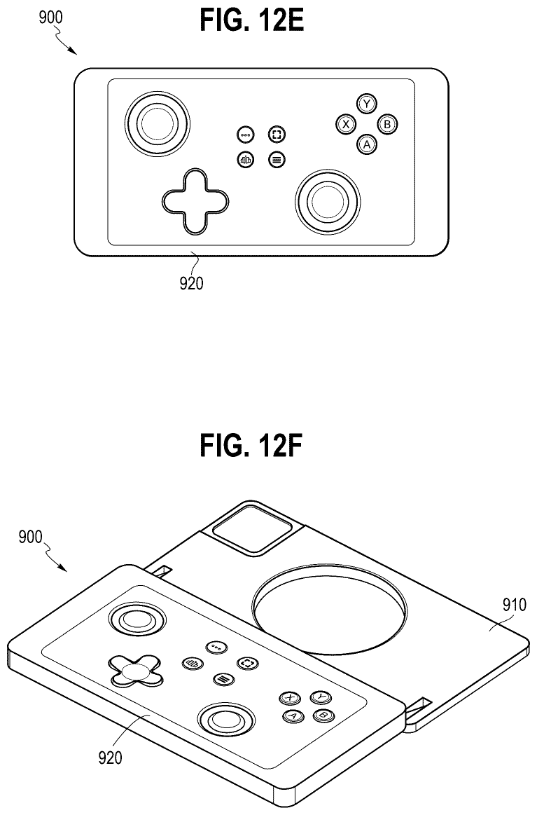

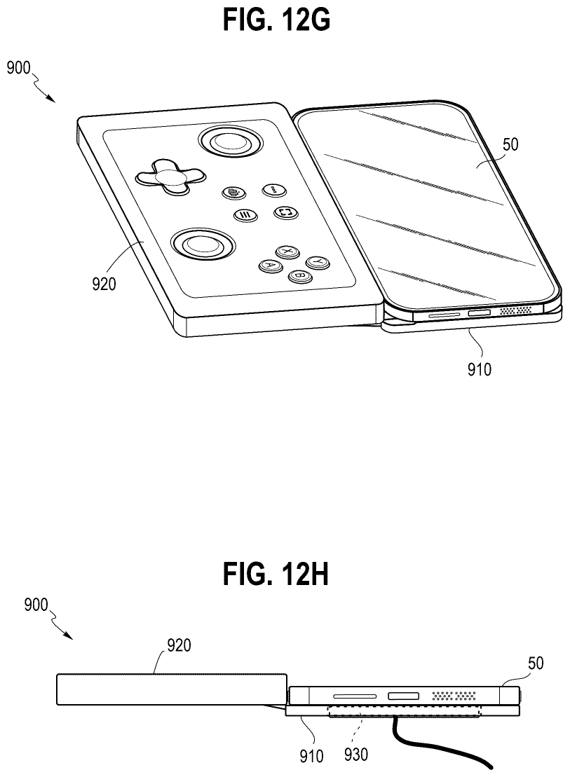

As mentioned above, any suitable game controller configuration can be used. FIGS. 12A-12H illustrate some additional example alternatives. The game controller 800 in FIGS. 12A-12D comprises a first portion 810 comprising an opening 825 for a removable (magnetic or non-magnetic) connector and a second portion 820 comprising user input devices. The first and second portions 810, 820 are slidable with respect each other via tracks 814, 816. Latches 824, 826 can lock the first and second portions 810, 820 into place in different positions. FIG. 12A shows the game controller 800 in an open, game playing position, and FIG. 12B shows the game controller 800 in a closed, non-game-playing position. When in the game playing position, the first portion 810 slides away from the second portion 820 to reveal the user input devices. As shown in FIGS. 12C and 12D, when the game controller 800 is in the game playing position, a mobile device 50 can be placed on top of the first portion 810, and a removable charger 830 can be placed within the opening 820. FIGS. 12E-12H illustrate a game controller 900 of an alternative embodiment in which the first portion 910 is located below the second portion 920. As shown in FIG. 12H, in this alternative, the removable charger 930 is below a plane defined by the bottom surface of the second portion 920.

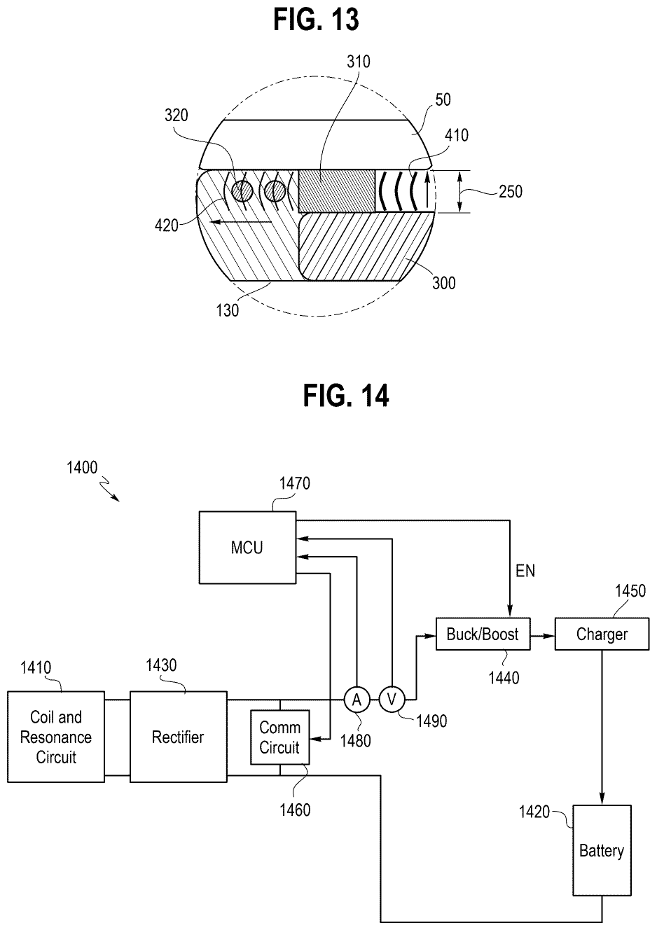

Returning to FIG. 10A, FIG. 10A references a portion 13, and FIG. 13 is an expanded view of that portion. As shown in FIG. 13 (and in other figures), the game controller 100 of this embodiment also comprises an optional parasitic charging coil 320, which can be concentrically located around the attachment magnet 310, when present. In this example, the parasitic charging coil 320 is directly or indirectly adjacent to the attachment magnet 310; here, as an outer ring with respect to the attachment magnet 310. Also, in this example, the attachment magnet 310 is exposed outside of the body of the game controller 100, while the parasitic charging coil 320 is embedded inside the body of the game controller 100. Other configurations are possible.

In this embodiment, the parasitic charging coil 320 is configured to collect stray power wirelessly transmitted from the magnetic charger 300 when the magnetic charger 300 is placed in the opening 200. The game controller 100 can use this collected stray power to, as an example, charge one or more batteries of the game controller 100 (e.g., located in the handles 110, 120 of the game controller 100). FIG. 13 illustrates this operation. As shown in FIG. 13, the magnetic charger 300 provides a primary magnetic power field 410 to wirelessly charge the mobile device 50. However, a residual magnetic power field 420 is also provided generally perpendicular to the primary magnetic power field 410. This residual magnetic power field 420, which may be otherwise lost, can be siphoned out by the parasitic charging coil 320 and used to charge one or more batteries of the game controller 100.

The size/configuration of the parasitic charging coil 320 can play a role in how much of the residual magnetic field 410 is collected, and it may be desired to siphon off a relatively-small amount of power, so the mobile device 50 and/or magnetic charger 300 does not detect a problem (and/or there is no actual problem even if such siphoning is detected). The parasitic charging coil 320 and/or charging system of the game controller 100 can be tuned for this purpose. For example, if the primary magnetic power field 410 is about 20W, the system can be tuned to siphon only about 500 mW (about 2.5%) of the power from the residual magnetic power field 410. In some embodiments, the air gap 250 provides a space for the collection of the residual magnetic power field 410, and the size of the air gap 250 may be a factor in how much of the residual magnetic power field 410 is collected. In other embodiments, the air gap is not present, and the residual magnetic power field bleeds outside of the axial path of the magnetic charger to the mobile device.

As mentioned above, the game controller 100 can use the collected stray power to charge one or more of its batteries (e.g., located in the handle(s) 110, 120 or bridge 130), which power processor(s) and/or other components in the game controller 100. The game controller 100 can comprise any suitable charging system for this purpose. For example, the game controller's charging system can automatically (e.g., upon connection to the magnetic charger 300) siphon off the residual power from the magnetic charger 300 to charge, for example, the game controller's battery passively and automatically (e.g., without user initiation or without user knowledge). In other embodiments, the user is able to configure if, when, and/or how such charging occurs. Also, the game controller 100 can use software to estimate how much power from the magnetic charger 300 is going to the mobile device 50 and siphon off an amount of power under the threshold at which there would not be enough power to charge the mobile device 50 or otherwise raise the suspicion of a problem.

The game controller 100 can use any suitable type of charging system, and FIG. 14 is an illustration of one example charging system 1400 that can be used. It should be understood that this is merely one example and that other implementations can be used. As shown in FIG. 14, a coil and resonance circuit 1410 (e.g., the parasitic charging coil) is used to charge a battery 1420 in the game controller 100. In this example, the charging system 1400 comprises a rectifier 1430 in communication with a buck/boost circuit 1440, which is in communication with a charger 1450 to charge the battery 1420. A rectifier 1430 is also in communication with a communication circuit 1460. A master control unit (MCU) 1470 is in communication with the buck/boost circuit 1440 and the communication circuit 1460, as well as with current (“A”) 1480 and voltage (“V”) 1490. The MCU 1470 can comprise one or more processors, and one or more non-transitory computer-readable media having program instructions stored therein that, when executed by the one or more processors, individual or in combination, cause the MCU 1470 to perform various functions, such as, but not limited to, some or all of the functions described herein.

The design of the charging system 1400 of this embodiment is based on Qi2.0 Power Receiver Example 2(5 W), but the Comm Circuit 1460 and the buck/boost circuit 1440 are different because this circuit is being used to draw power. Optionally, if the battery is full, the second part of the circuit can effectively turn off, so the resulting circuit can function only as prescribed by Qi2.0.

The communications modulator comprises a Rcm in series with a switch (represented by the communication circuit 1460 in the drawing). This can be used to allow the game controller 100 to interact with and charge directly off of the magnetic charger 300 without the mobile device 50 present. This can also be used to short the coil 1410 when the game controller 100 does not want to absorb power and communication is not possible (e.g., “harvest mode”).

The buck/boost circuit 1440 can be configured to regulate the input voltage to charge the battery 1420 in the game controller 100. In harvesting mode, the input voltage may not be controllable, and the buck/boost circuit 1440 can be configured to handle significant span. In the case where the game controller 100 is communicating and can control the throughput power, the throughput power can be set to an ideal charge voltage for the charger. The MCU 1470 controlled enable allows for disconnecting the output. The buck/boost circuit 1440 (or another circuit) can be configured to measure voltage and current from protection and to be able to set the system in the correct mode.

Many alternatives to these embodiments are possible. For example, U.S. patent application Ser. No. 18/369,000 (“Mobile Game Controller with Floating Magnetic Connector”) and Ser. No. 18/369,025 (“Mobile Game Controller with Magnetic Connector and Power Handling/Management Methods for Use Therewith”), which are hereby incorporated by reference, describe embodiments which can be used in combination with the embodiments presented herein.

It is intended that the foregoing detailed description be understood as an illustration of selected forms that the invention can take and not as a definition of the invention. It is only the following claims, including all equivalents, which are intended to define the scope of the claimed invention. Finally, it should be noted that any aspect of any of the embodiments described herein can be used alone or in combination with one another.

What is claimed is:

1. A game controller comprising:
a first handle;
a second handle; and
a bridge coupled with the first and second handles, wherein the bridge is configured to allow a removable charger positioned on one side of the bridge to wirelessly charge a mobile device positioned on an opposite side of the bridge.

2. The game controller of claim 1, wherein the bridge comprises an opening sized to accept the removable charger.

3. The game controller of claim 2, wherein:
the removable charger comprises a removable magnetic charger;
the game controller further comprises an attachment magnet positioned around the opening; and
the attachment magnet comprises:
a first end configured to magnetically attach with the mobile device; and
a second end configured to magnetically attach with the removable magnetic charger.

4. The game controller of claim 3, wherein:
the opening is shaped in a circle; and
the attachment magnet comprises a ring concentrically located around the opening.

5. The game controller of claim 4, further comprising:
a parasitic charging coil concentrically located around the attachment magnet.

6. The game controller of claim 2, wherein:
the removable charger comprising a removable magnetic charger; and
the game controller further comprises a non-magnetic material positioned around the opening and configured to create a gap between the removable magnetic charger and the mobile device when the removable magnetic charger and mobile device are magnetically coupled.

7. The game controller of claim 1, wherein:
the first and second handles are movable between a first position and a second position;
in the first position, the first and second handles are positioned to allow the mobile device to be positioned between the first and second handles; and
in the second position, inside edges of the first and second handles contact edges of the mobile device to secure the mobile device to the game controller.

8. The game controller of claim 1, wherein:
the removable charger comprising a removable magnetic charger;
the first and second handles are movable between a first position and a second position; and
in the second position, the mobile device is positioned above inside edges of the first and second handles when the mobile device magnetically attaches to the removable magnetic charger.

9. The game controller of claim 1, further comprising:
an electrical connector configured to mate with a corresponding electrical connector on the mobile device, wherein the electrical connectors are configured to communicate game data between the game controller and the mobile device.

10. The game controller of claim 1, wherein:
the removable charger comprises a removable magnetic charger: and the bridge comprises a thickness sufficiently small to allow the removable magnetic charger to wirelessly charge the mobile device.

11. A game controller comprising:
a first portion comprising at least one user input device; and
a second portion movable with respect to the first portion, wherein the second portion is configured to allow a removable charger position on one side of the second portion to wirelessly charge a mobile device positioned on an opposite side of the second portion.

12. The game controller of claim 11, wherein one of the first and second portions is slidable with respect to the other of the first and second portions.

13. The game controller of claim 11, wherein the removable charger comprises a removable magnetic charger.

14. A game controller comprising:
a first handle;
a second handle;
a battery;
a bridge coupled with the first and second handles, wherein the bridge comprises an opening sized to accept a removable magnetic charger through one side of the opening; and
a coil located around the opening;
wherein:
the removable magnetic charger is configured to generate a primary magnetic power field to wirelessly charge a mobile device positioned adjacent an opposite side of the opening;
the removable magnetic charger is configured to generate a residual magnetic power field; and
the coil is configured to siphon power from the residual magnetic power field to charge the battery in the game controller.

15. The game controller of claim 14, further comprising:
an attachment magnet positioned around the opening;
wherein:
the opening is shaped in a circle;
the attachment magnet comprises a ring concentrically located around the opening; and
the coil is concentrically located around the attachment magnet.

16. The game controller of claim 14, further comprising a charging system.

17. The game controller of claim 16, wherein the charging system comprises a rectifier, a communication circuit, a buck/boost circuit, and/or a processor.

18. The game controller of claim 14, wherein:
the first and second handles are movable between a first position and a second position;
in the first position, the first and second handles are positioned to allow the mobile device to be positioned between the first and second handles; and
in the second position, inside edges of the first and second handles contact edges of the mobile device to secure the mobile device to the game controller.

19. The game controller of claim 14, wherein:
the first and second handles are movable between a first position and a second position; and
in the second position, the mobile device is positioned above the inside edges of the first and second handles when the mobile device is magnetically attached to the removable magnetic charger.

20. The game controller of claim 14, further comprising:
an electrical connector configured to mate with a corresponding electrical connector on the mobile device, wherein the electrical connectors are configured to communicate game data between the game controller and the mobile device.
